(19) United States
(12) Patent Application Publication
(10) Pub. No.: US 2009/0147688 A1
(43) Pub. Date: Jun. 11, 2009

(54) RADIO COMMUNICATION TERMINAL DEVICE, RADIO COMMUNICATION BASE STATION DEVICE, AND RADIO COMMUNICATION METHOD

(75) Inventors: Atsushi Matsumoto, Ishikawa (JP); Daichi Imamura, Kanagawa (JP); Yoshihiko Ogawa, Kanagawa (JP); Sadaki Futagi, Ishikawa (JP); Takashi Iwai, Ishikawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/298,473

(22) PCT Filed: Apr. 24, 2008
(86) PCT No.: PCT/JP2007/058837

§ 371 Date: Feb. 11, 2009

(30) Foreign Application Priority Data
Apr. 25, 2006 (JP) 2006-121058
Jan. 11, 2007 (JP) 2007-003661

(51) Int. Cl. H04J 3/14

(52) U.S. Cl. 370/242

(57) ABSTRACT

It is possible to provide a radio communication terminal device, a radio communication base station device, and a radio communication method capable of improving the resource use efficiency and the throughput in synchronous random access. A resource control unit (111) has a table correlating a combination or resources used by UE with a plurality of different pilot patterns, so that a selectable resource is selected from the table at random. The selected resource and the pilot signal correlated with the resource are transmitted to Node B. Node B has the same table as the table owned by the resource control unit (111). According to the pilot signal transmitted from each UE, Node B judges the resource which has caused a conflict and the resource which has caused the conflict is reported to each UE. The UE in which the conflict has occurred re-transmits only the resource which has caused the conflict.

### TECHNICAL FIELD

The present invention relates to a radio communication terminal apparatus, radio communication base station apparatus and radio communication method using synchronous random access, whereby timing synchronization is established between apparatuses.

### BACKGROUND ART

The 3GPP RAN LTE (Long Term Evolution) is currently studying two types of random access; synchronous random access and non-synchronous random access. Non-synchronous random access is the kind of random access that is used to acquire the initial synchronization when a Node B and UE are not timing-synchronized with each other.

On the other hand, synchronous random access is being studied as a method for transmitting scheduling request and so on. One feature of synchronous random access is that a base station (herein after referred to as “Node B”) and a mobile station (herein after referred to as “UE”) are timing-synchronized with each other. Therefore, the reception timing of the random access transmitted from each UE at the Node B is synchronized with desired frame (slot) timing.

As a method of allocating frequencies and time resources to individual UEs in synchronous random access, Non-Patent Document 1 proposes a method of allocating a predetermined fixed size of resources for synchronous random access. In this case, for the predetermined fixed size, it is necessary to secure resources to match the process gain to satisfy the required received quality of the UE located in the neighborhood of cell edges as a predetermined fixed size. Therefore, all UEs in the cell perform synchronous random access in the same fixed format.

Here, FIG. 1 shows an uplink subframe format under study by the LTE. The subframe format shown in FIG. 1 is composed of LB (Long Block) #1 to LB #6, SB (Short Block) #1 and SB #2, and SB #1 is interposed between LB #1 and LB #2 and SB #2 is interposed between LB #5 and LB #6. Furthermore, a CP (Cyclic Prefix) is added to the beginning of each block of LB #1 to LB #6, SB #1 and SB #2 arranged in this way. Here, when, for example, one subframe is secured as a resource for synchronous random access, all UEs transmit symbols in a one-subframe length through synchronous random access.

Non-Patent Document 1: 3GPP TR 25.814 V1.2.2, “Physical Layer Aspects for Evolved UTRA (Release 7)”, 9.1.2 Physical channel procedure, 2006-3

### DISCLOSURE OF INVENTION

### Problems to be Solved by the Invention

However, according to the technique described in aforementioned Non-Patent Document 1, since all UEs perform random access in the same subframe length, when a collision occurs between transmission data, all data transmitted by the UEs are discarded and the UEs retransmit the same data as the data at which collision has occurred. Therefore, when transmission data collides between the UEs and a retransmission occurs, the utilization rate of system resources in random access increases considerably, and, as a result, the collision rate of transmission data including retransmission data increases, which results in a problem of deteriorating retransmission efficiency.

It is therefore an object of the present invention to provide a radio communication terminal apparatus, radio communication base station apparatus and radio communication method that reduce the rate of collisions of transmission data including retransmission data even when collision of transmission data occurs in synchronous random access and improve retransmission efficiency.

### Means for Solving the Problem

The radio communication terminal apparatus according to the present invention adopts a configuration including: a received quality acquisition section that acquires received quality of a received signal; a resource control section that controls a size of resources used for synchronous random access based on the acquired received quality; and a transmitting section that transmits data of synchronous random access using the resources of a controlled size.

The radio communication base station apparatus according to the present invention adopts a configuration including: a receiving section that receives known signals transmitted from a plurality of radio communication terminal apparatuses; and a known signal decision section that has information that associates a plurality of different known signals with transmission positions of resources used in a subframe and sizes of the resources and decides the presence or absence of collision of resources based on the transmission positions of the resources and sizes of the resources based on the transmission positions and the sizes of the resources corresponding to the known signals transmitted from the plurality of radio communication terminal apparatuses.

The radio communication method according to the present invention includes: acquiring received quality of a received signal; providing information that associates a plurality of different known signals with transmission positions of resources used in a subframe and sizes of the resources and randomly selecting a selectable resource from the associated information based on the acquired received quality; transmitting synchronous random access data and a known signal that is associated with the selected resource to the radio communication base station apparatus using the selected resource; and providing the same information as the associated information and deciding the presence or absence of collision of resources based on the transmission positions of the resources and sizes of the resources based on the transmission positions of the resources and sizes of the resources corresponding to the plurality of known signals transmitted from the radio communication terminal apparatus.

### ADVANTAGEOUS EFFECT OF THE INVENTION

According to the present invention, even when collision of transmission data occurs in synchronous random access, it is possible to reduce the rate of collision of transmission data including retransmission data and improve retransmission efficiency.

### BRIEF DESCRIPTION OF DRAWINGS

FIG. 1 shows an uplink subframe format;

FIG. 2 is a block diagram showing a configuration of a UE according to Embodiment 1 of the present invention;

FIG. 3 shows a table which the resource control section shown in FIG. 2 has;

FIG. 4 shows resources transmitted with pilot pattern numbers 0, 1 and 6;

FIG. 5 is a block diagram showing a configuration of a Node B according to Embodiment 1 of the present invention;

FIG. 6 shows a table which the resource control section has;

FIG. 7 shows a table according to Embodiment 2 of the present invention;

FIG. 8 shows a collision rate of each LB when the table shown in FIG. 7 is used;

FIG. 9 shows a table which the resource control section has;

FIG. 10 shows another table which the resource control section has;

FIG. 11 shows a further table which the resource control section has;

FIG. 12 is a block diagram showing a configuration of a UE according to Embodiment 3 of the present invention;

FIG. 13 is a block diagram showing a configuration of a Node B according to Embodiment 3 of the present invention;

FIG. 14 shows the correspondences between pilot pattern numbers and LB positions used upon initial transmission;

FIG. 15 shows the correspondences between pilot pattern numbers and retransmission priorities;

FIG. 16 shows operation examples of the UE and Node B according to Embodiment 3 of the present invention;

FIG. 17 shows a table according to Embodiment 4 of the present invention;

FIG. 18 shows operation examples of a UE and Node B according to Embodiment 4 of the present invention;

FIG. 19 shows other operation examples of the UE and Node B according to Embodiment 4 of the present invention;

FIG. 20 shows a table according to Embodiment 5 of the present invention;

FIG. 21 shows operation examples of a UE and Node B according to Embodiment 5 of the present invention; and

FIG. 22 shows another uplink subframe format.

### BEST MODE FOR CARRYING OUT THE INVENTION

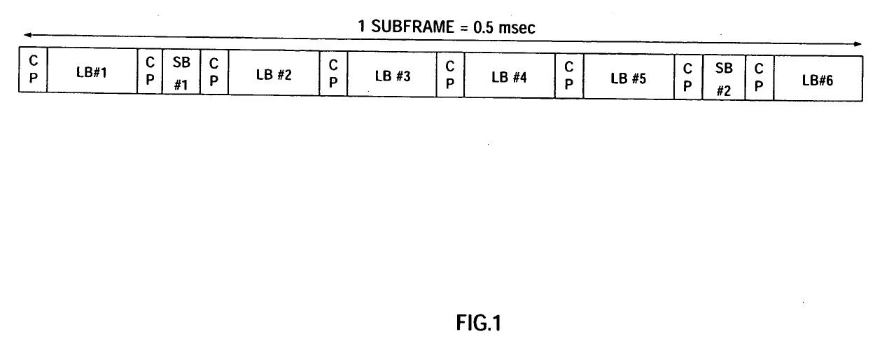

Now, embodiments of the present invention will be described in detail with reference to the accompanying drawings. The following embodiments will explain a transmitting apparatus (mobile station: “UE”) and receiving apparatus (base station: “Node B”) to which the DFT-s-OFDM scheme is applied by way of example. Furthermore, the transmission format used for synchronous random access is assumed to be the LTE uplink subframe format shown in FIG. 1 and each UE assumes LB as a minimum transmission unit of transmission data and uses resources of LB×n (n=1, 2, . . . , 6), that is, in LB units. Furthermore, pilot signals are orthogonally multiplexed in SBs of the subframe format shown in FIG. 1 between UEs. The pilot signals arranged in the SBs need only to be orthogonally multiplexed according to FDMA (Frequency Division Multiple Access), CDMA (Code Division Multiple Access), TDMA (Time Division Multiple Access) and so on.

### EMBODIMENT 1

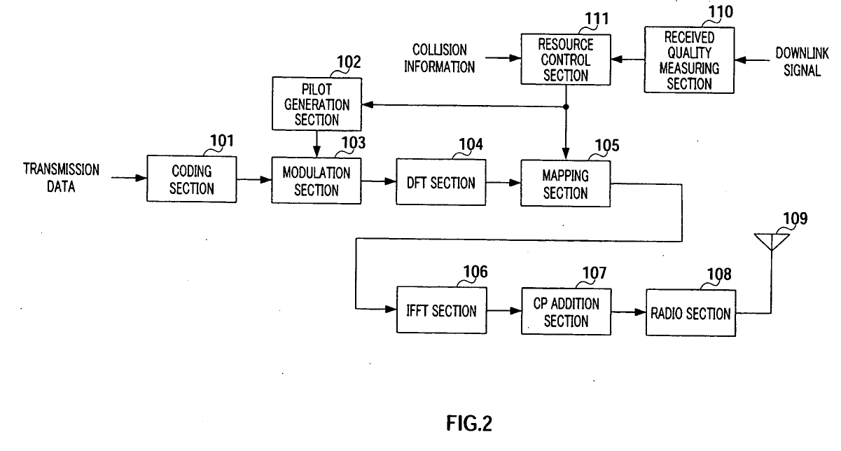

FIG. 2 is a block diagram showing a configuration of a UE according to Embodiment 1 of the present invention. In FIG. 2, coding section 101 encodes transmission data and outputs the coded data to modulation section 103.

Pilot generation section 102 generates a pilot signal in a pilot pattern reported from resource control section 111, which will be described later, and outputs the pilot signal generated, to modulation section 103.

Modulation section 103 modulates the coded data outputted from coding section 101 and the pilot signal outputted from pilot generation section 102, and outputs the modulated signal to DFT (Discrete Fourier Transform) section 104.

DFT section 104 applies the discrete Fourier transform to the modulated signal outputted from modulation section 103, and outputs the signal subjected to the discrete Fourier transform, to mapping section 105.

Mapping section 105 arranges the transmission data outputted from DFT section 104 in LBs of a subframe format and pilot signals in SBs according to the resource sizes and transmission data arrangement positions (herein after referred to as “LB positions”) reported from resource control section 111, which will be described later, and outputs the subframe to IFFT (Inverse Fast Fourier Transform) section 106.

IFFT section 106 applies the inverse fast Fourier transform to the signal outputted from mapping section 105, and outputs the signal subjected to the inverse fast Fourier transform to CP addition section 107.

CP addition section 107 copies the signals arranged in the LBs and SBs in the subframe format, for a predetermined size from the rear end of each block, and adds the copied signals (CP) to the beginning of each block. The signal to which a CP is added, is outputted to radio section 108.

Radio section 108 applies predetermined radio transmission processing such as D/A conversion, up-conversion to the signal outputted from CP addition section 107 and transmits the signal subjected to the radio transmission processing from antenna 109.

Received quality measuring section 110 as a received quality acquisition section measures received quality of a downlink signal, and outputs the measurement result to resource control section 111.

Resource control section 111 determines the resource size (the number of LBs used: “LB length”) of transmission data based on the received quality of the downlink signal outputted from received quality measuring section 110 upon the initial transmission of the random access channel. Resource control section 111 is provided with a table that associates pilot patterns with LB positions and LB lengths beforehand, randomly selects one combination based on the table from among selectable LB positions according to the determined resource size, and outputs the selected LB position to mapping section 105, and furthermore outputs the pilot pattern corresponding to the selected LB position, to pilot generation section 102.

Furthermore, when retransmitting the random access channel, resource control section 111 identifies the colliding LB based on collision information (i.e. colliding pilot pattern numbers or colliding LB numbers) reported through the downlink, and determines a resource size to retransmit only the colliding LB. Resource control section 111 then randomly selects one combination from among the selectable LB positions according to the determined resource size, based on the table, and outputs the selected LB position to mapping section 105 and the pilot pattern corresponding to the selected LB position, to pilot generation section 102.

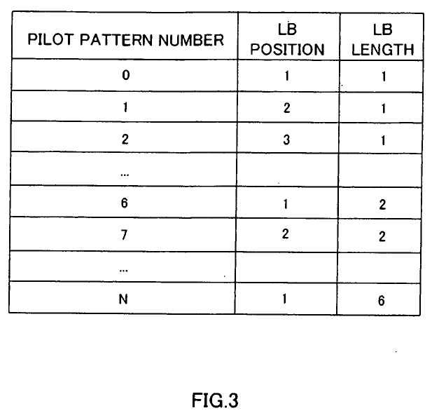

Here, the table which resource control section 111 has will be explained using FIG. 3. First, in synchronous random access, suppose the resource size and the position information of the resource determined by the UE are uniquely allocated to the pilot pattern. The table shown in FIG. 3 shows the correspondences between pilot pattern numbers, LB positions and LB lengths. Different pilot pattern numbers designate different pilot patterns and suppose these pilot patterns are orthogonal to each other.

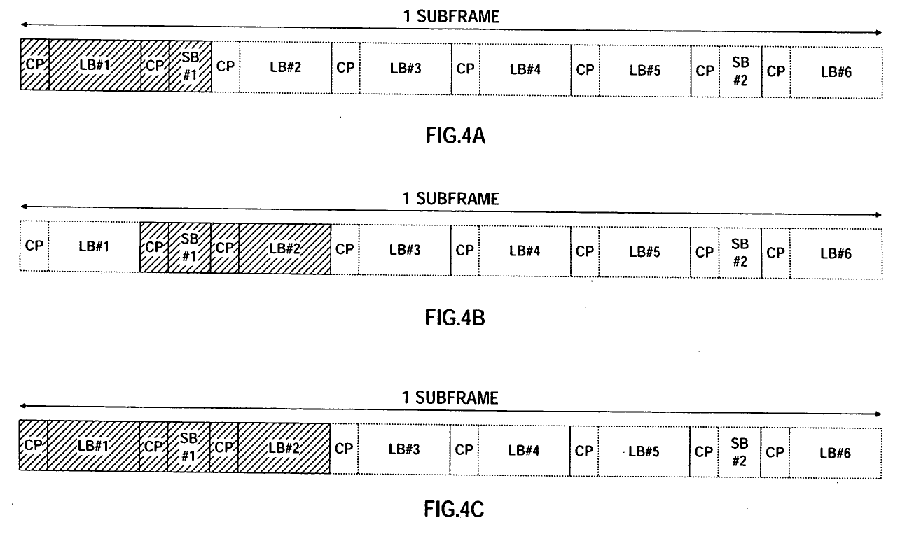

FIGS. 4A to 4C show transmission resources (i.e. LBs and SBs) corresponding to pilot pattern numbers 0, 1 and 6 shown in FIG. 3 for reference. FIGS. 4A to 4C show resources used with diagonally shaded areas and show resources not used with white areas.

Next, a method of determining resources using the table shown in FIG. 3 will be explained more specifically. In the UE, resource control section 111 takes propagation loss and so on into account and determines a resource size whereby the process gain to satisfy the required received quality can be obtained based on the received quality of a downlink signal measured by received quality measuring section 110. When, for example, the determined resource size is LB length 1, pilot pattern numbers 0 to 5 are selectable with reference to the table in FIG. 3.

When the determined resource size is LB length 1, resource control section 111 randomly selects one pilot pattern so as to reduce the rate of collision between UEs out of pilot pattern numbers 0 to 5 selectable from the table in FIG. 3. The selected pilot pattern number is reported to pilot generation section 102 and the LB position corresponding to the selected pilot pattern number is reported to mapping section 105.

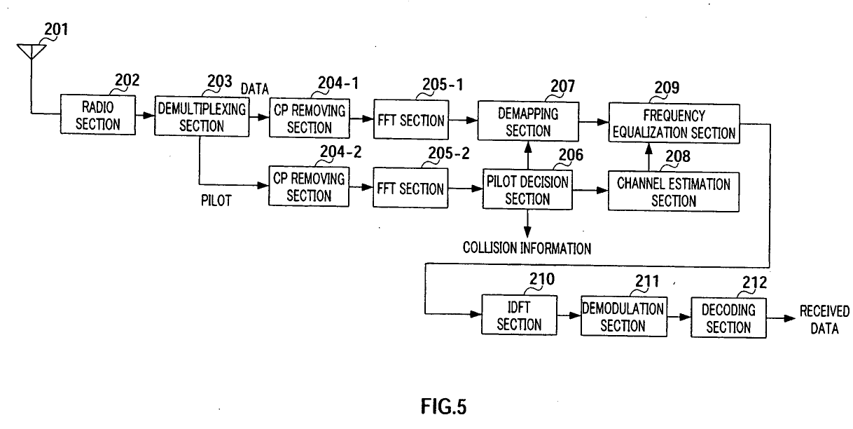

FIG. 5 is a block diagram showing a configuration of a Node B according to Embodiment 1 of the present invention. In this figure, radio section 202 down-converts a signal received via antenna 201, applies predetermined radio receiving processing such as down-conversion, A/D conversion and outputs the signal subjected to the radio receiving processing to demultiplexing section 203.

Demultiplexing section 203 demultiplexes the data signals and pilots multiplexed in a the radio subframe outputted from radio section 202 into the respective data signals pilots, outputs the demultiplexed data signals to CP removing section 204-1 and the demultiplexed pilot signals to CP removing section 204-2.

CP removing section 204-1 removes the CPs from the data signals outputted from demultiplexing section 203, and outputs the data signals from which the CPs are removed, to FFT (Fast Fourier Transform) section 205-1. Likewise, CP removing section 204-2 removes the CPs from the pilot signals outputted form demultiplexing section 203, and outputs the pilot signals from which the CPs are removed to FFT section 205-2.

FFT section 205-1 applies the fast Fourier transform to the data signals outputted from CP removing section 204-1, and outputs the signals subjected to the fast Fourier transform, to demapping section 207. Likewise, FFT section 205-2 applies the fast Fourier transform to the pilot signals outputted from CP removing section 204-2, and outputs the signals subjected to the fast Fourier transform, to pilot decision section 206.

Pilot decision section 206 is provided with the same table as the table resource control section 111 shown in FIG. 2 has, decides the resource size and the positions of the data mapped in the subframe corresponding to the pilot pattern, from the table, based on the pilot pattern of pilot signals outputted from FFT section 205-2, and reports the decided resource size and data positions to demapping section 207. At this moment, pilot decision section 206 decides whether or not the random access channels transmitted from a plurality of UEs are colliding in the same LB's, and transmits, when a collision is identified, collision information to all UEs. Furthermore, pilot decision section 206 outputs the pilot signals to channel estimation section 208. Details of pilot decision section 206 will be described later.

Demapping section 207 extracts data signals from the corresponding time and frequency positions on the subframe outputted from FFT section 205-1, based on the resource size and data positions outputted from pilot decision section 206, and outputs the extracted data signals to frequency equalization section 209.

Channel estimation section 208 estimates channel variation based on the pilot signals outputted from pilot decision section 206, and outputs an estimate of channel variation to frequency equalization section 209 as a channel estimation value.

Frequency equalization section 209 equalizes the channel distortion of the data signals outputted from demapping section 207, based on the channel estimation value outputted from channel estimation section 208, and outputs the equalized data signal to IDFT (Inverse Discrete Fourier Transform) section 210.

IDFT section 210 applies the inverse discrete Fourier transform to the data signals outputted from frequency equalization section 209, and outputs the data signal subjected to the inverse discrete Fourier transform to demodulation section 211.

Demodulation section 211 demodulates the data signals outputted from IDFT section 210, and outputs the demodulated data signals to decoding section 212. Decoding section 212 applies decoding processing to the data signals outputted from demodulation section 211 and acquires received data.

Here, the operation of pilot decision section 206 shown in FIG. 5 will be explained. First, suppose UE #1 selects pilot pattern number 1 and transmits the random access channel in the position shown in FIG. 4B and UE #2 selects pilot pattern number 6 and transmits the random access channel in the position shown in FIG. 4C, both UEs using the same time and frequency band.

In this case, since LB #2 is used by both UE #1 and UE #2, a collision between the UEs occurs in LB #2 upon reception by the Node B, and the Node B cannot receive LB #2. Since no collision occurs in LB #1, the data of LB #1 transmitted by UE #2 can be received.

Pilot decision section 206 of the Node B detects the pilot signals of UE #1 and UE #2 which are user-multiplexed in SB #1. As a result of this detection, the pilot signal transmitted by UE #1, that is, pilot pattern 1 and the pilot signal transmitted by UE #2, that is, pilot pattern 6, are identified.

When the pilot patterns are identified, pilot decision section 206 decides whether or not a plurality of UEs are using the same resources based on the table shown in FIG. 3. Here, pilot decision section 206 decides that there is a UE that transmitted LB #2 and a UE that transmitted LB #1 and LB #2, and therefore decides that a plurality of UEs are using LB #2. In this way, when the plurality of UEs are using the same resources, pilot decision section 206 decides that collision has occurred, and reports collision information to the UEs. In this case, since the Node B cannot specify the UEs in which collision has occurred, collision information may be reported to all UEs under the control of the Node B.

Next, in synchronous random access, the operation of UEs when a collision occurs between the UEs will be explained. Here, the aforementioned example, that is, a case where UE #1 selects pilot pattern number 1 and transmits the random access channel in the position shown in FIG. 4B and UE #2 selects pilot pattern number 6 and transmits the random access channel in the position shown in FIG. 4C, both UEs using the same time and frequency band, will be explained. In this case, it has already been explained that UE #1 collides with UE #2 in LB #2 in the Node B.

The UE under the control of the Node B receives the collision information reported from the Node B, and resource control section 111 of the UE decides whether or not the transmission data of the UE has collided based on the received collision information. First, when the collision information indicates a colliding pilot pattern number, resource control section 111 identifies the colliding LB based on the table shown in FIG. 3 and the resources used for previous transmission. If the collision information indicates the colliding LB number, processing for identifying the colliding LB is not particularly needed.

In this way, UE #1 and UE #2 identify the colliding LB (here, LB #2), and, since the respective UEs can recognize that the resources used for the previous transmission collide, the colliding LB alone needs to be retransmitted. That is, resource control section 111 of UE #1 reallocates resources of the data allocated in LB #2 at previous transmission and transmits the data. Furthermore, since the data allocated in LB #1 at the previous transmission has already been received by the Node B, resource control section 111 of UE #2 needs not retransmit the data and reallocates only the resources for the data allocated in LB #2 and transmits the data. This allows efficient use of resources and allows the rate of collision upon retransmissions to be reduced.

In this way, according to Embodiment 1, combinations of resources used by UEs are associated with a plurality of different pilot patterns in synchronous random access and associated information is shared between the UE and Node B, so that the Node B can identify the colliding resources between the UEs, the Node B reports information identifying the colliding resources to the UEs and the UEs retransmit the colliding resources alone, and, by this means, it is possible to improve resource utilization efficiency and reduce the rate of collisions upon retransmissions, thereby improving throughput.

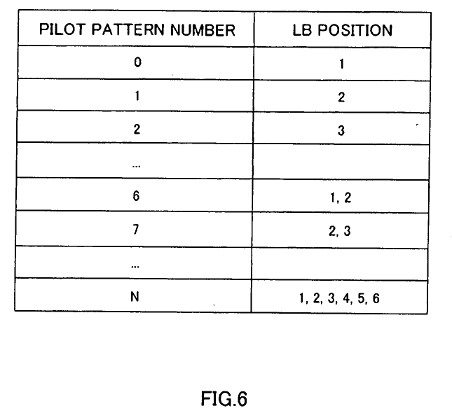

In the present embodiment, pilot patterns are associated with allocation of resources according to the LB position, which is the first position of an LB used and the LB length which is the resource size used as shown in FIG. 3, but, as shown in FIG. 6, if an LB position is assumed to correspond to the positions of all LBs in use, the LB length needs not be expressly associated. However, the LB length is substantially associated also in the case shown in FIG. 6.

Furthermore, the present embodiment has been explained assuming that received quality measuring section 110 measures the received quality of a downlink signal, but the Node B may also measure the received quality of the reference signal transmitted from a UE and use the measured received quality reported to the UE using the downlink control signal. This is made possible since time alignment control is adopted between the Node B and UE in synchronous random access.

The received quality reported on the downlink may be expressed as a CQI (Channel Quality Indicator), CSI (Channel State Information) and so on.

Furthermore, received quality in the present embodiment may also be expressed as reception CIR, reception SIR, reception CINR, reception power, interference power and so on.

### EMBODIMENT 2

The configurations of a UE and a Node B according to Embodiment 2 of the present invention are similar to the configurations in Embodiment 1 shown in FIG. 2 and FIG. 5, and therefore FIG. 2 and FIG. 5 will be used and overlapping explanations will be omitted.

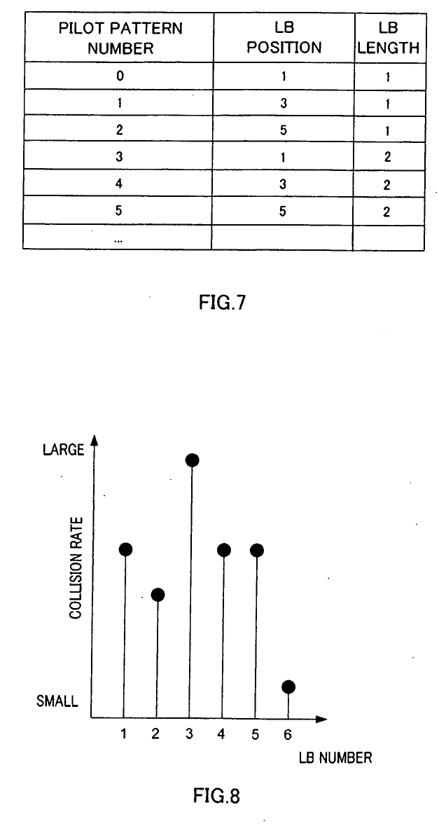

A table according to Embodiment 2 of the present invention will be explained using FIG. 7. In the table shown in FIG. 7, LB positions associated with pilot pattern numbers are limited to odd-numbered LBs. FIG. 8 shows the rate of collisions for each LB when this table is used. In FIG. 8, the horizontal axis stands for an LB number and the vertical axis stands for the rate of collisions. As is understood from this figure, even-numbered LBs have relatively low rates of collisions compared to the rates of collisions of the odd-numbered LBs. That is, LBs having low rates of collisions can be intentionally created.

Therefore, consider allocating important information such as UE ID, information bit and control data to the LBs of low collision rates. Here, a case where resources of LB length 2 are used will be explained by way of example. In the case of LB length 2, selectable LB positions are LB #1, LB #3 and LB #5 according to the table shown in FIG. 7. The UE randomly selects one LB position from among these selectable LB positions. When the UE selects LB #5, LB #5 and LB #6 are used. As for LB #5 and LB #6, as shown in FIG. 8, an even-numbered LB, that is, LB #6, has a relatively lower collision rate, and therefore important information is allocated in LB #6. Here, examples of important information include control information such as resource request, the systematic bits (information bit) of error correcting code and UE ID which is user identification information, while examples of unimportant information, which is preferentially allocated to odd-numbered LBs, include information about the parity bits of error correcting code.

In this way, Embodiment 2 places limits on the combinations of resources when drawing associations between combinations of resources used by UEs and a plurality of different pilot patterns, thereby allowing the rate of collusions to vary from one resource to another and allocating important information to resources having low collision rates, and, consequently, transmitting important information to the Node B through fewer transmissions and improving throughput.

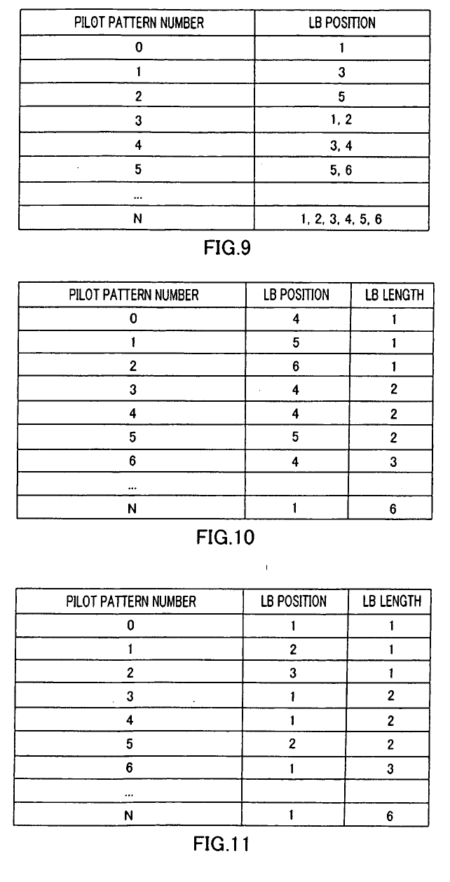

The present embodiment associates the pilot patterns with resource allocation using the LB position, which is the first position of the LB in use, and the LB length, which is the resource size in use as shown in FIG. 7, but, as shown in FIG. 9, if the LB position is the positions of all LBs in use, the LB length need not be expressly associated. However, the LB length is substantially associated also in the case shown in FIG. 9.

The present embodiment sets selectable LB positions to odd-numbered LB #1, LB #3 and LB #5, but may also set selectable LB positions to even-numbered LB #2, LB #4 and LB #6, reduce the rate of collisions for odd-numbered LBs and map important information to odd-numbered LBs. Furthermore, when the LB length is 3 or less, selectable LB positions may also be set to LB #4 to LB #6 as shown in FIG. 10 so as to reduce the rates of collisions of LB #1 to LB #3. Likewise, if the LB length is 3 or less, as shown in FIG. 11, selectable LB positions may also be set to LB #1 to LB #3 so as to reduce the rate of collisions of LB #4 to LB #6.

### EMBODIMENT 3

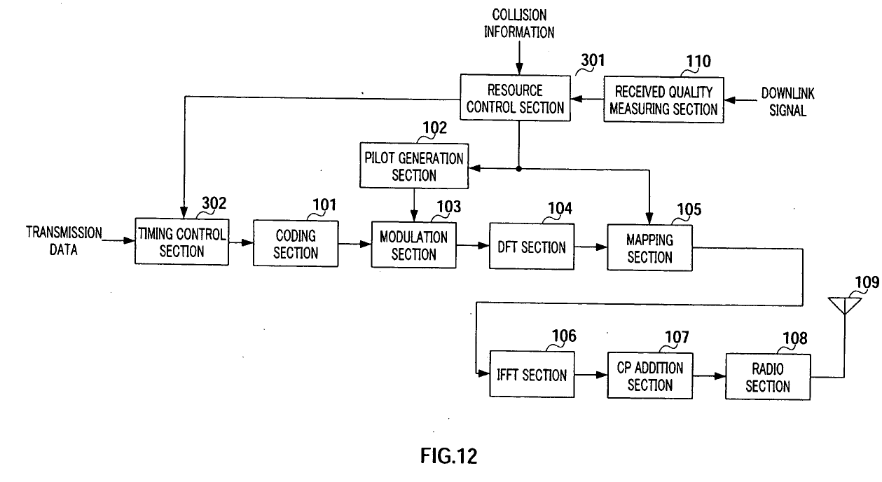

FIG. 12 is a block diagram showing a configuration of a UE according to Embodiment 3 of the present invention. FIG. 12 differs from FIG. 2 in that timing control section 302 is added and resource control section 111 is changed to resource control section 301.

In FIG. 12, resource control section 301 decides whether or not to carry out retransmission based on collision information transmitted from a Node B, which will be described later. Upon making a decision that retransmission is carried out, resource control section 301 decides transmission timing from a pilot signal and outputs a timing control signal to timing control section 302. Timing control is not performed upon initial transmission.

Timing control section 302 controls timing at which transmission data is inputted to coding section 101 based on the timing control signal outputted from resource control section 301. That is, timing control section 302 switches data transmission timing.

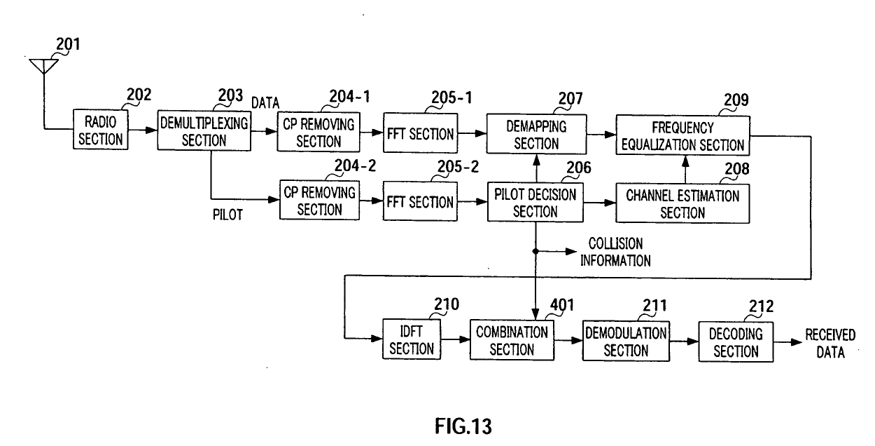

FIG. 13 is a block diagram showing a configuration of a Node B according to Embodiment 3 of the present invention. FIG. 13 differs from FIG. 5 in that combination section 401 is added.

In FIG. 13, combination section 401 saves data that prevents collision based on collision information outputted from pilot decision section 206 and combines, when colliding data is retransmitted, the saved data and retransmission data. The combined data is outputted to demodulation section 211.

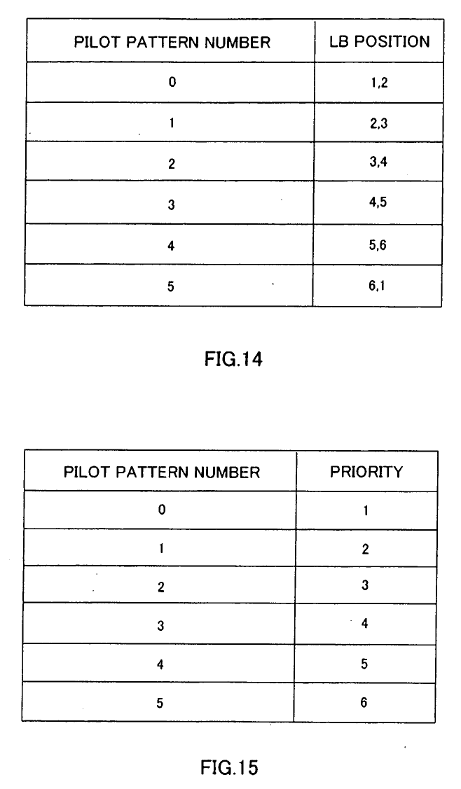

Here, FIG. 14 and FIG. 15 show tables which resource control section 301 has shown in FIG. 12 and by pilot decision section 206 shown in FIG. 13. FIG. 14 shows the correspondences between pilot pattern numbers and LB positions used upon initial transmission. Here, a case will be described here where two consecutive LBs can be selected by the UE upon initial transmission, for convenience of explanation. Furthermore, FIG. 15 shows the correspondences between pilot pattern numbers and retransmission priorities.

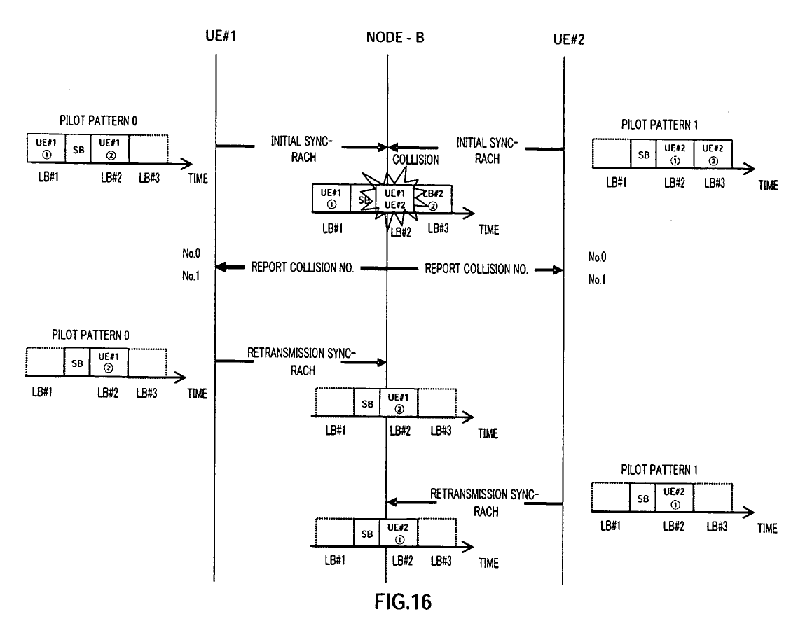

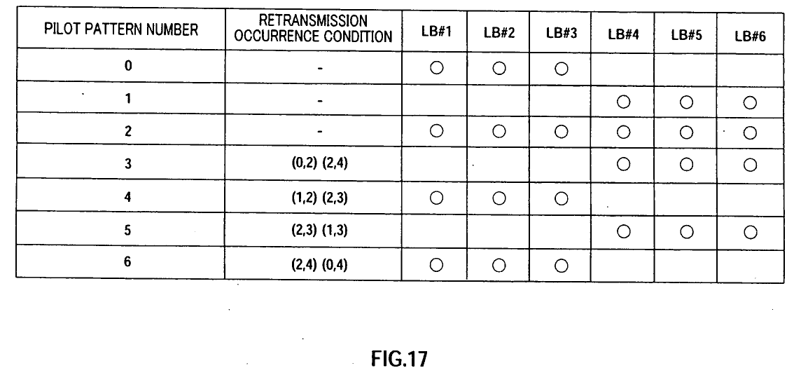

Next, a case where as a result of UE #1 and UE #2 having the configuration shown in FIG. 12 attempting synchronous random access simultaneously, transmission data collides and retransmission occurs will be explained using FIG. 16.

First, upon initial transmission, suppose UE #1 transmits the random access channel using pilot pattern 0, LB #1 and LB #2, and UE #2 transmits the random access channel using pilot pattern 1, LB #2 and LB #3.

In this case, since LB #2 is used by both UE #1 and UE #2, the random access channels transmitted in LB #2 collide between these UEs. As has been explained in Embodiment 1, the Node B decides the presence or absence of collision based on a plurality of pilot signals received, and transmits collision information about the downlink. UE #1 and UE #2 receive the collision information transmitted over the downlink and decide that there are colliding data blocks in the transmission data they have transmitted, based on the collision information.

UE #1 and UE #2, having recognized that a collision has occurred, perform a retransmission of the colliding data (collision data). To be more specific, each UE decides the transmission timing of the collision data. In this case, as shown in FIG. 15, retransmission priorities are associated with pilot patterns beforehand and since pilot pattern 0 collides with pilot pattern 1 in the present embodiment, upon retransmission, pilot pattern 0 is transmitted first and then pilot pattern 1 is transmitted. That is, collision data is retransmitted in order of UE #1 and UE #2. In this case, the same pilot pattern numbers as those upon collision are used as the pilot pattern numbers upon retransmission of each UE. Furthermore, collision data is retransmitted using the same resources as those upon collision.

The Node B saves part of the initial transmission data of each UE (i.e. data that is not colliding) in a buffer, and, when the Node B receives retransmission data (collision data) from UE #1 and UE #2, if the pilot pattern number of the data saved in the buffer matches the pilot pattern number of retransmission data, such data is regarded as data to be combined. The present embodiment combines the data transmitted using pilot pattern 0 for UE #1 and combines the data transmitted using pilot pattern 1 for UE #2. However, the position of combination between initial transmission data and retransmission data is decided from the resource position when data saved in the buffer is received and the resource position of the retransmission data. This makes it possible to also handle, for example, IR (Incremental Redundancy) based HARQ (Hybrid Auto Repeat request), which requires the positional relationship at the time of combination.

In this way, Embodiment 3 associates combinations of resources used by a UE with a plurality of different pilot patterns, associates the order in which the UE performs retransmission with pilot patterns, uses the pilot pattern used upon initial transmission for retransmission, transmits data colliding between UEs in the order corresponding to the pilot pattern and transmits retransmission data at the same resources position as the colliding resource position upon initial transmission, and can thereby prevent collision of retransmission data, allows the receiving side to combine the initial transmission data with retransmission data, provides combination gain through retransmission, and can thereby successfully perform RACH transmission with fewer retransmissions and improve throughput.

### EMBODIMENT 4

The configurations of a UE and a Node B according to Embodiment 4 of the present invention are similar to the configurations in Embodiment 3 shown in FIG. 12 and FIG. 13, and therefore FIG. 12 and FIG. 13 will be used and overlapping explanations will be omitted.

A table according to Embodiment 4 of the present invention will be explained using FIG. 17. However, the present embodiment will assume two types of the number of LBs used, namely 3 LBs and 6 LBs. Furthermore, in a 3 LB transmission, different pilot pattern numbers define transmission patterns orthogonal to each other. Furthermore, when the initial 3 LB transmission collides with a 6 LB transmission, the process returns to initial transmission processing without performing retransmission processing on the 3 LB transmission. Furthermore, in the 6 LB transmission, when a collision occurs at all LB positions, the process returns to initial transmission processing without performing retransmission processing.

The table shown in FIG. 17 shows the correspondences between pilot pattern numbers, retransmission occurrence conditions (pilot pattern number at which collision has occurred) and LB positions at which data is transmitted (shown by circles in the figure). Here, pilot patterns 0 to 2 are used upon initial transmission, pilot patterns 3 and 4 are used for retransmission when a collision occurs upon the initial transmission and pilot patterns 5 and 6 are used upon second retransmission when a collision occurs upon retransmission. Furthermore, pilot patterns 3 to 6 are associated with retransmission occurrence conditions, and more specifically, sets of pilot pattern numbers where collision has occurred are shown. For example, a set of pilot patterns 0 and 2, and a set of pilot patterns 2 and 4 are associated with pilot pattern 3 as retransmission occurrence conditions. This means that if collision occurs between pilot patterns 0 and 2 or between pilot patterns 2 and 4 used for previous transmission, pilot pattern 3 is used this time. The same applies to pilot patterns 4 to 6, too.

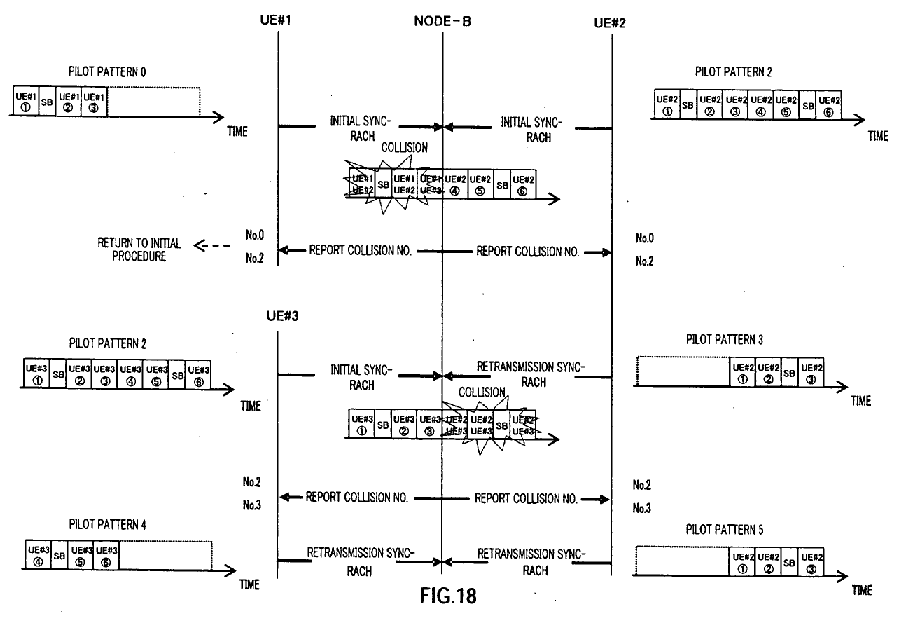

Next, operation examples of a UE and a Node B according to Embodiment 4 of the present invention will be explained using FIG. 18.

First, upon initial transmission, suppose UE #1 selects pilot pattern 0 and transmits data using LB #1 to LB 43 according to pilot pattern 0 shown in FIG. 17. On the other hand, suppose UE #2 selects pilot pattern 2 and transmits data using LB #1 to LB #6 corresponding to pilot pattern 2 shown in FIG. 17.

In this case, when UE #1 and UE #2 perform synchronous random access at the same time, collision of transmission data occurs in LB #1 to LB #3. As has been explained in Embodiment 1, the Node B decides the presence or absence of collision based on a plurality of pilot signals received and transmits collision information about the downlink. UE #1 and UE #2 receive the collision information transmitted over the downlink and decides, based on the collision information, that there are collision blocks in the transmission data they have transmitted.

UE #2, having recognized that a collision has occurred, performs a retransmission of the colliding data (collision data). On the other hand, since collision has occurred at all LBs upon the initial transmission, UE #1 returns to the initial transmission processing without moving to retransmission processing.

As the retransmission processing of UE #2, a pilot pattern number used for retransmission is searched from the retransmission occurrence conditions using the table shown in FIG. 17. Here, since collision has occurred between pilot pattern 0 and pilot pattern 2, pilot pattern 3 is used for retransmission.

Here, suppose UE #3 attempts new synchronous random access. In this case, UE #3 selects pilot pattern 2 and determines LB #1 to LB #6 as resources to be used. As a result, the retransmission data of UE #2 collides with the initial transmission data of UE #3 in LB #4 to LB #6. Based on the collision decision result, the Node B reports the collision information about the downlink. UE #2 and UE #3 receive the collision information transmitted over the downlink, and decide, based on the collision information, that the transmission data they have transmitted has collided.

UE #2 and UE #3, having recognized that a collision has occurred, perform a second retransmission and a retransmission of the colliding data (collision data) respectively. Likewise, E#2 and UE #3 search pilot pattern numbers at retransmission from the retransmission occurrence conditions using the table shown in FIG. 17. Since the retransmission data has collided, UE #2 uses a second retransmission table and UE #3 uses a retransmission table. That is, UE #2 uses pilot pattern 5 and UE #3 uses pilot pattern 4. These UEs retransmit collision data using resources associated with the pilot pattern numbers defined in the table shown in FIG. 17. Therefore, UE #2 uses LB #4 to LB #6 and UE #3 uses LB #1 to LB #3 to retransmit collision data.

The Node B saves part of the initial transmission data of each UE (i.e. data that is not colliding) in a buffer and can determine, when retransmission data (collision data) is received, the pilot pattern number of data transmitted to which the retransmission data corresponds based on the table shown in FIG. 17, and the Node B thereby combines the data saved in the buffer with the retransmission data. Furthermore, since the Node B can likewise determine the resource positions of the data saved in the buffer and retransmission data using the table shown in FIG. 17, the resource positions may be rearranged first and then combined if necessary.

In this way, Embodiment 4 associates combinations of resources used by UEs with a plurality of different pilot patterns, presets the pilot patterns to be used upon initial transmission, retransmission and second retransmission, respectively, determines the pilot patterns to be used upon retransmission and second retransmission based on the pilot patterns used previously, and can thereby reduce the number of retransmissions, allows the receiving side to combine the initial transmission data and retransmission data, provides combination gain through retransmission, and can thereby successfully perform RACH transmission with fewer retransmissions and improve throughput.

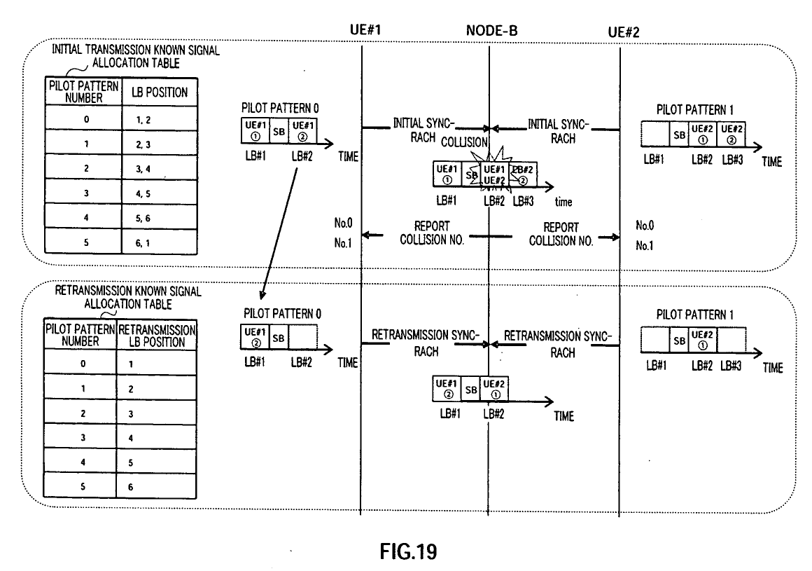

As shown in FIG. 19, the same pilot pattern number as the pilot pattern number used upon initial transmission may also be used for retransmission. However, FIG. 19 shows a case where the number of LBs used upon initial transmission is 2 LBs and the number of LBs used for retransmission is 1 LB. Furthermore, different tables are used upon initial transmission and for retransmission. That is, the table in which the association between pilot pattern numbers and resources used are redefined for retransmission is used.

### EMBODIMENT 5

Configurations of a UE and a Node B according to Embodiment 5 of the present invention are similar to the configurations of Embodiment 3 shown in FIG. 12 and FIG. 13, and therefore FIG. 12 and FIG. 13 will be used and overlapping explanations will be omitted.

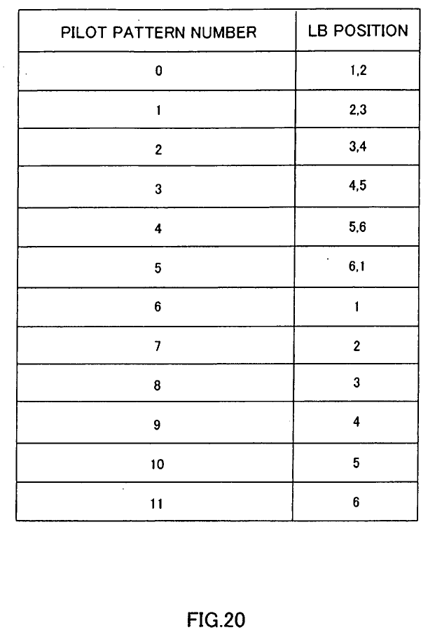

As shown in FIG. 20, the table in Embodiment 5 of the present invention shows the correspondences between pilot pattern numbers and LB positions. Here, suppose the maximum number of LBs that can be transmitted by the UE is 2 and consecutive LBs are used, for simplicity.

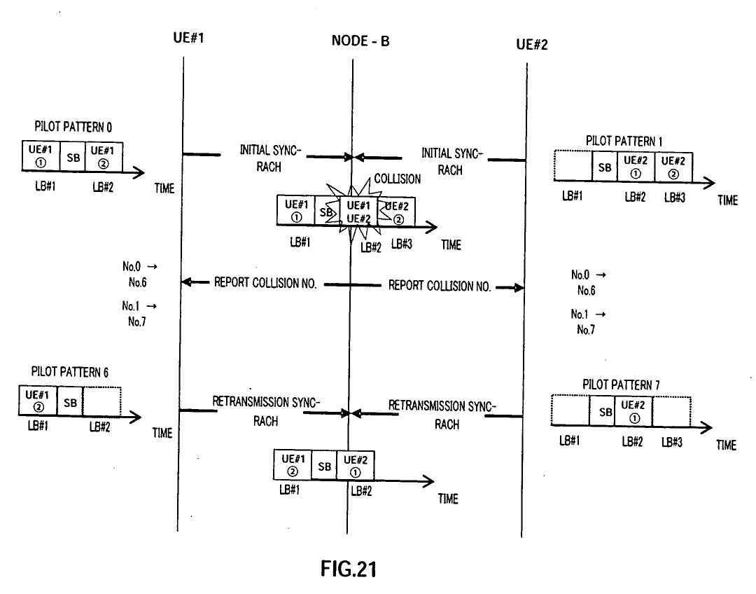

Next, operation examples of the UE and Node B according to Embodiment 5 of the present invention will be explained using FIG. 21.

First, upon initial transmission, suppose UE #1 transmits the random access channel using pilot pattern 0, LB #1 and LB #2, and UE #2 transmits the random access channel using pilot pattern 1, LB #2 and LB #3.

In this case, since LB #2 is used by both UE #1 and UE #2, the random access channel transmitted in LB #2 collides between these UEs. As explained in Embodiment 1, the Node B decides the presence or absence of collision based on a plurality of pilot signals received. Upon deciding that there is collision, the Node B selects a pilot pattern number which the UE uses upon retransmission, so that retransmission data does not collide between UEs, associates the selected pilot pattern number with collision information and transmits the pilot pattern number on the downlink. UE #1 and UE #2 receive the pilot pattern number to be used for retransmission transmitted over the downlink and collision information and decides based on the collision information that there are colliding data blocks in the transmission data they have transmitted.

The collision data is retransmitted using the pilot pattern number reported from the Node B and the corresponding resources.

The Node B saves part of initial transmission data of each UE (i.e. data that is not colliding) in a buffer and combines, when retransmission data (collision data) is received, the data transmitted using the pilot pattern number specified by the Node B to the UE (retransmission data), with the corresponding data saved in the buffer.

In this way, according to Embodiment 5, the Node B identifies a colliding resource, selects a pilot pattern number used by a UE for retransmission, reports information identifying the colliding resources and the selected pilot pattern number to the UE, and can thereby prevent collision of retransmission data, allows the receiving side to combine the initial transmission data and retransmission data and provide combination gain through retransmission, and can thereby successfully perform RACH transmission with fewer retransmissions and improve throughput.

Pilot pattern numbers to be used for retransmission are reported on the downlink, but the present invention is not limited to this and any method can be used as long as resources to be used for retransmission can be reported to the UE.

Furthermore, when all transmission data collide, the process may be returned to initial transmission processing without performing retransmission processing.

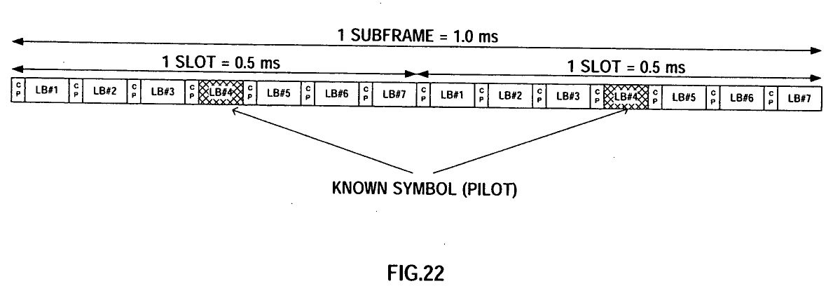

The subframe format used in the above described embodiments is not limited to the frame format shown in FIG. 1. For example, as shown in FIG. 22, the blocks making up one subframe may be entirely composed of LBs. According to this format, one subframe is composed of two slots, arranged side by side, each made up of LB #1 to LB #7, and pilot signals are multiplexed with predetermined LBs and transmitted.

Furthermore, the subframe may also be called a frame or slot. Furthermore, pilots used in the above described embodiments may also be known signals such as preambles.

Furthermore, in the above described embodiments, when a plurality of LBs are combined, pilot patterns and LBs are associated so as to give serial LB numbers, but the present invention is not limited to this and any number of LBs may be combined and associated with pilot patterns.

Furthermore, according to the above described embodiments, data transmitted with LBs may vary from one LB to another or may be the same (i.e. repetitions) among LBs. Furthermore, data to be retransmitted may be the same as or may be different from the data transmitted previously.

Furthermore, according to the above described embodiments, time-frequency conversion and frequency-time conversion are realized using FFT and IFFT, but DFT and IDFT may also be used respectively.

Furthermore, the above described embodiments have explained the DFT-s-OFDM configuration by way of is example, but the present invention is not limited to this and a general single carrier transmission configuration may also be used.

Furthermore, the above described embodiments have explained the application of frequency domain equalization processing as a precondition, but this processing need not always be required, and when frequency domain equalization processing is not carried out, CP addition section 107 and CP removing sections 204-1 and 204-2 are not necessary.

Furthermore, according to the above described embodiments, pilot decision section 206 identifies pilot patterns of a plurality of UEs using pilot signals converted to frequency components by FFT section 205-2, but pilot patterns of a plurality of UEs may also be identified through time correlation processing using pilot signals which are time domain signals.

Furthermore, according to the above described embodiments, orthogonal and quasi-orthogonal sequences such as (Cyclic Shift-) Zadoff Chu sequence, M sequence, Hadamard sequence or (orthogonal) Gold sequence may also be used as pilot signals. Furthermore, the number of retransmission may also be associated with a cyclic shift sequence having a different Cyclic Shift-Zadoff Chu sequence. Furthermore, a sequence number having a different Zadoff Chu sequence may also be used as a pilot pattern. Furthermore, a cyclic shift sequence having a different Cyclic Shift-Zadoff Chu sequence may also be used as the pilot pattern.

Furthermore, in the above described embodiments, a UE attempting new synchronous random access may monitor a downlink, select resources other than collision resources and transmit data together with the pilot pattern that matches the selected resources.

Furthermore, in the above described embodiments, resources may also be expressed as data blocks.

Furthermore, in the above described embodiments, association between pilot signals and transmission resources may be changed on a per cell basis. Furthermore, association between pilot signals and transmission resources may also be reported to a UE through a broadcast channel (also called “BCH” or “PCH”), data channel (also called “DSCH,” “DPDCH,” “DCH” or “SDCH”) or control channel (also called “SCCH” or “DPCCH”). Furthermore, association between pilot signals and transmission resources may also be changed according to the number of UEs and so on.

For example, although with the above embodiments cases have been described where the present invention is configured by hardware, the present invention may be implemented by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosures of Japanese Patent Application No. 2006-121058, filed on Apr. 25, 2006, and Japanese Patent Application No. 2007-003661, filed on Jan. 11, 2007, including the specifications, drawings and abstracts, are incorporated herein by reference in their entirety.

### INDUSTRIAL APPLICABILITY

The radio communication terminal apparatus, radio communication base station apparatus and radio communication method according to the present invention can improve resource utilization efficiency in synchronous random access, improve throughput and are applicable to a mobile radio communication system.

1. A radio communication terminal apparatus comprising:
a received quality acquisition section that acquires received quality of a received signal;
a resource control section that controls a size of resources used for synchronous random access based on the acquired received quality; and
a transmitting section that transmits data of synchronous random access using the resources of a controlled size.

2. The radio communication terminal apparatus according to claim 1, wherein the resource control section randomly selects transmission positions of resources used in a subframe.

3. The radio communication terminal apparatus according to claim 1, further comprising a known signal generation section that generates known signals orthogonal to known signals used by other radio communication terminal apparatuses.

4. The radio communication terminal apparatus according to claim 1, wherein the resource control section has information that associates a plurality of different known signals with transmission positions of resources used in a subframe and resource sizes.

5. The radio communication terminal apparatus according to claim 1, wherein the resource control section acquires information about colliding resources from a radio communication base station apparatus, decides based on the information about the colliding resources whether or not resources transmitted from the radio communication terminal apparatus have collided, and retransmits only the colliding resources when the resources have collided.

6. The radio communication terminal apparatus according to claim 5, wherein the resource control section causes the transmission positions of resources used for retransmission in a subframe to differ from the transmission position used previously or to be randomly selected positions.

7. The radio communication terminal apparatus according to claim 4, wherein the resource control section has information that associates a plurality of different known signals with transmission positions of resources used in a subframe and resource sizes, so that selectable resources are limited.

8. The radio communication terminal apparatus according to claim 7, further comprising a mapping section that maps important information including at least one of control information, information bit and UE ID, to resources having a relatively low collision rate.

9. The radio communication terminal apparatus according to claim 4, wherein the resource control section uses the same known signal as the known signal used upon initial transmission for retransmission and uses the same resources as resources in which collision occurred upon a previous transmission for retransmission.

10. The radio communication terminal apparatus according to claim 9, wherein the resource control section has information that associates a transmission sequence making retransmission timing vary from that of other radio communication terminal apparatuses with known signals.

11. The radio communication terminal apparatus according to claim 1, wherein the resource control section has information that associates a plurality of different known signals with transmission positions of resources used in a subframe and resource sizes for retransmission.

12. The radio communication terminal apparatus according to claim 11, wherein the resource control section uses the same known signal as the known signal used upon initial transmission for retransmission.

13. The radio communication terminal apparatus according to claim 4, wherein the resource control section uses a known signal specified by a radio communication base station apparatus for retransmission.

14. A radio communication base station apparatus comprising:
a receiving section that receives known signals transmitted from a plurality of radio communication terminal apparatuses; and
a known signal decision section that has information that associates a plurality of different known signals with transmission positions of resources used in a subframe and sizes of the resources and decides the presence or absence of collision of resources based on the transmission positions of the resources and sizes of the resources based on the transmission positions and the sizes of the resources corresponding to the known signals transmitted from the plurality of radio communication terminal apparatuses.

15. The radio communication base station apparatus according to claim 14, wherein the known signal decision section reports, when there is a resource collision, information about the colliding resources to the plurality of radio communication terminal apparatuses.

16. The radio communication base station apparatus according to claim 14, further comprising a combination section that combines an initial transmission signal received and a retransmission signal.

17. A radio communication method comprising the steps of:
acquiring received quality of a received signal;
providing information that associates a plurality of different known signals with transmission positions of resources used in a subframe and sizes of the resources and randomly selecting a selectable resource from the associated information based on the acquired received quality;
transmitting synchronous random access data and a known signal that is associated with the selected resource to the radio communication base station apparatus using the selected resource; and
providing the same information as the associated information and deciding the presence or absence of collision of resources based on the transmission positions of the resources and sizes of the resources based on the transmission positions of the resources and sizes of the resources corresponding to the plurality of known signals transmitted from the radio communication terminal apparatus.

18. The radio communication method according to claim 17, further comprising the steps of, when there is a resource collision, in the radio communication base station apparatus:
reporting information about the colliding resource to the plurality of radio communication terminal apparatuses; and
deciding based on the information about the colliding resource whether or not resources transmitted from a specific radio communication terminal apparatus have collided and retransmitting, when the resources collide, only the colliding resources to the radio communication base station apparatus.
